(19) United States
(12) Patent Application Publication
(10) Pub. No.: US 2017/0085009 A1
(43) Pub. Date: Mar. 23, 2017

(54) LOW-PROFILE, BROAD-BANDWIDTH, DUAL-POLARIZATION DIPOLE RADIATING ELEMENT

(71) Applicant: Paul Robert Watson, Kanata (CA)

(72) Inventor: Paul Robert Watson, Kanata (CA)

(21) Appl. No.: 14/858,778

(22) Filed: Sep. 18, 2015

(51) Int. Cl. H01Q 21/26; H01Q 1/50

(52) U.S. Cl. CPC H01Q 21/26; H01Q 1/50

(57) ABSTRACT

An antenna having a first dipole element configured to emit or receive electromagnetic signals in a first polarization direction wherein the first dipole is fed by a first inclined balun and a second dipole element configured to emit or receive electromagnetic signals in a second polarization direction that is orthogonal to the first polarization direction wherein the second dipole is fed by a second inclined balun.

### TECHNICAL FIELD

The present disclosure generally relates to antenna systems and, more particularly, to dual-polarization dipole radiating elements for use in antenna systems.

### BACKGROUND

Base station antennas are often mounted in high traffic metropolitan areas. As a result, compact antenna modules are favored over bulkier ones because compact modules are aesthetically pleasing as well as easier to install and service. Many base station antennas deploy arrays of antenna elements to achieve advanced antenna functionality, e.g., beam forming, etc. Accordingly, techniques and architectures for reducing the profile of an individual antenna element as well as for reducing the size of the antenna element arrays are desired.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In general the present specification discloses a compact, broad-bandwidth dual-polarization dipole antenna having an inclined balun. The dipole antenna has a lower dipole probe coupled to an upper dipole probe.

An inventive aspect of the disclosure is an antenna having a first dipole element configured to emit or receive electromagnetic signals in a first polarization direction wherein the first dipole is fed by a first inclined balun and a second dipole element configured to emit or receive electromagnetic signals in a second polarization direction that is orthogonal to the first polarization direction wherein the second dipole is fed by a second inclined balun.

Yet another inventive aspect of the disclosure is a method of using an antenna to receive a signal. The method entails receiving, by a first dipole element having a first inclined balun, electromagnetic signals in a first polarization direction, receiving, by a second dipole element having a second inclined balun, the electromagnetic signals in a second polarization. The second polarization direction is orthogonal to the first polarization direction.

Yet another inventive aspect of the disclosure is a wireless apparatus comprising an antenna including a first dipole element configured to emit or receive electromagnetic signals in a first polarization direction, wherein the first dipole has a first inclined balun, a second dipole element configured to emit or receive electromagnetic signals in a second polarization direction, wherein the second polarization direction is orthogonal to the first polarization direction, and the second dipole has a second inclined balun. The wireless apparatus further includes a wireless transceiver connected to the antenna. The wireless apparatus may be a base station transceiver or mobile communication device.

### BRIEF DESCRIPTION OF THE DRAWINGS

These and other features of the disclosure will become more apparent from the description in which reference is made to the following appended drawings.

FIG. 1 is a perspective view of a compact antenna element 10 having two orthogonal dipole elements and an inclined balun in accordance with an embodiment of the present invention.

FIG. 2 is a cross-sectional view of one of the dipole elements.

FIG. 3 is a top view of the antenna element.

FIG. 4 shows a detail of the top substrate in accordance with one embodiment.

FIG. 5 depicts the radiation pattern of the dipole elements.

FIG. 6 shows the co-polarization radiation and the cross-polarization radiation of the first dipole element (integrated in the compact antenna element 10) at 1.7 GHz, 2.2 GHz and 2.7 GHz.

FIG. 7 shows the co-polarization radiation and the cross-polarization radiation of the second dipole element for the same frequencies as shown in FIG. 5.

FIG. 8 is a flowchart presenting a method of receiving signals using the compact antenna element.

FIG. 9 is a flowchart presenting a method of transmitting signals using the compact antenna element.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

System operators require increasingly greater capacity for multiple input and multiple output (MIMO) antennas. One way to increase the capacity of such a system is to provide an antenna with orthogonal polarization directions.

Embodiments provide a compact antenna element having two orthogonal polarization directions. Embodiments further provide an antenna element with two independent input ports. The antenna element may comprise two collocated elements, e.g., two dipole radiating elements or simply “dipole elements”. The first dipole element may be rotated by an angle of 45° and the second dipole element may be rotated by an angle of −45°. The entire compact antenna element may have a height of about λ/6. In some embodiments the compact antenna element comprises cross dipoles wherein each of the cross dipoles includes a miniaturized balun. Also described herein are methods for operating the compact antenna element.

Embodiments of the invention advantageously increase the capacity of a MIMO antenna element, efficiently use available real estate and space, and reduce the size of the antenna element.

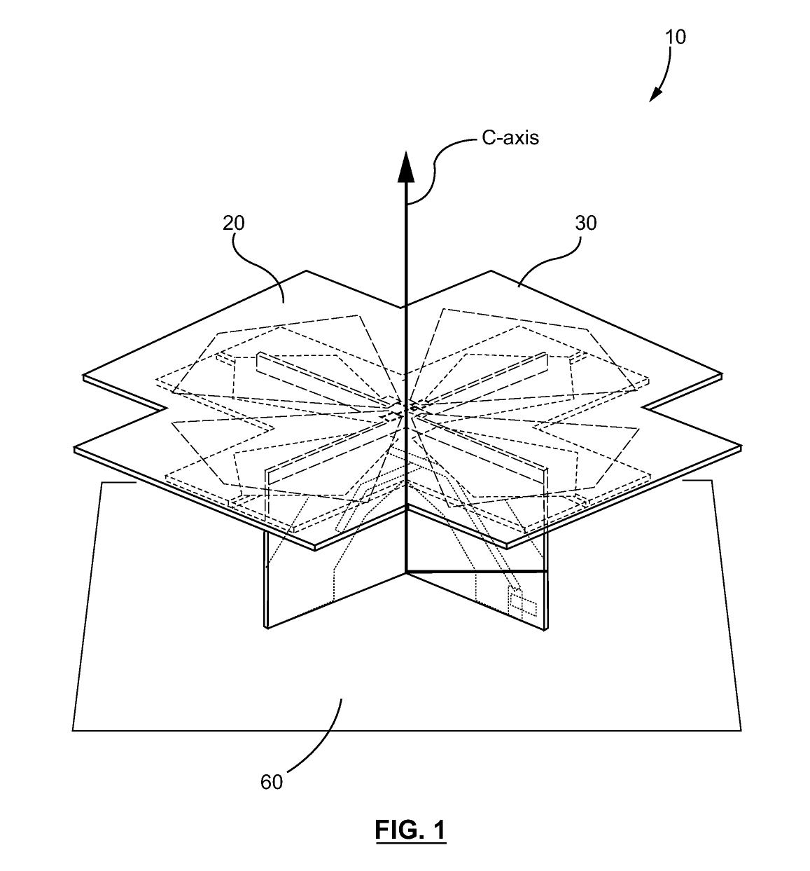

FIG. 1 is a perspective view of a compact antenna element 10 with two orthogonal polarizations and an inclined balun in accordance with one embodiment. The compact antenna 10 is composed of two dipole elements, namely a first dipole element 20 and a second dipole element 30. The compact antenna also includes, in the illustrated embodiments, an antenna reflector 60 which, in the illustrated embodiments, is a plane reflector (or flat sheet reflector) formed of a substantially flat electrically reflective material. The first dipole element 20 is configured to receive or emit an electromagnetic signal in a first polarization direction and the second dipole element 30 is configured to receive or emit an electromagnetic signal in a second polarization direction. For example, the first dipole element 20 may be a +45° polarized dipole element (relative to a plane of symmetry of the reflector 60) and the second dipole element 30 may be a −45° polarized dipole element. In other words, in the illustrated embodiment, the two polarized dipole elements 20, 30 are rotated relative to each other by 90°. The compact antenna element 10 is disposed on, or supported by, the antenna reflector 60 (e.g., antenna horizontal reflector; ground). In the illustrated embodiment, the height h (in the z-direction) of the compact antenna element 10 is about λ/6.5 wherein λ is the wavelength of the electromagnetic signal. It will be appreciated that for the purposes of this specification, the expression “about λ/6.5” means λ/6.5+/−10%, or alternatively, λ/6.5+/−5%, or even λ/6.5+/−2%. The length l (in the x-direction) of the compact antenna element 10 is about λ/2 in this embodiment and the width w (in the y-direction) of the compact antenna element 10 is about λ/2. In the illustrated embodiment, the compact antenna element 10 is symmetric around a central axis. For this specification “about λ/2” means λ/2+/−10%, or alternatively, λ/2+/−5%, or even λ/2+/−2%. In the illustrated embodiment, the total length, end to end, of the upper dipole probe is approximately λ/2 near the lower end of the frequency band while the total length, end to end, of the smaller, lower dipole probe is approximately λ/2 near the upper end of the frequency band.

FIG. 1 depicts how the first and second dipole elements 20, 30 are collocated to form the compact antenna element 10. These dipole elements 20, 30 may be disposed on a common antenna reflector 60 such that they are located around a central axis, the C-axis. The C-axis may be defined as leading through a central point of the antenna reflector 60 and being orthogonal to the antenna reflector 60. These dipole elements 20, 30 may be collocated such that they are symmetrically arranged around the C-axis.

The first and second dipole elements 20, 30 may include dielectric substrates. Each dielectric substrate is generally a thin film substrate having a thickness that is thinner than, in most cases, about 600 μm, or thinner than about 500 μm, although thicker substrate structures may be utilized. The thin film substrate includes an electrically insulating material, e.g., a dielectric material, with or without conductive layers. The substrate may be a laminate. The thin film substrate does not include a semiconductor material in some embodiments. Typical thin film substrate materials may be flexible printed circuit board (PCB) materials such as, for example, polyimide foils, polyethylene naphthalate (PEN) foils, polyethylene foils, polyethylene terephthalate (PET) foils, and liquid crystal polymer (LCP) foils. Further substrate materials that may be used include polytetrafluoroethylene (PTFE) and other fluorinated polymers, such as perfluoroalkoxy (PFA) and fluorinated ethylene propylene (FEP), Cytop® (amorphous fluorocarbon polymer), organic-ceramic woven laminate from Taconic, and HyRelex materials available from Taconic. The substrate could also be a multi-dielectric layer substrate.

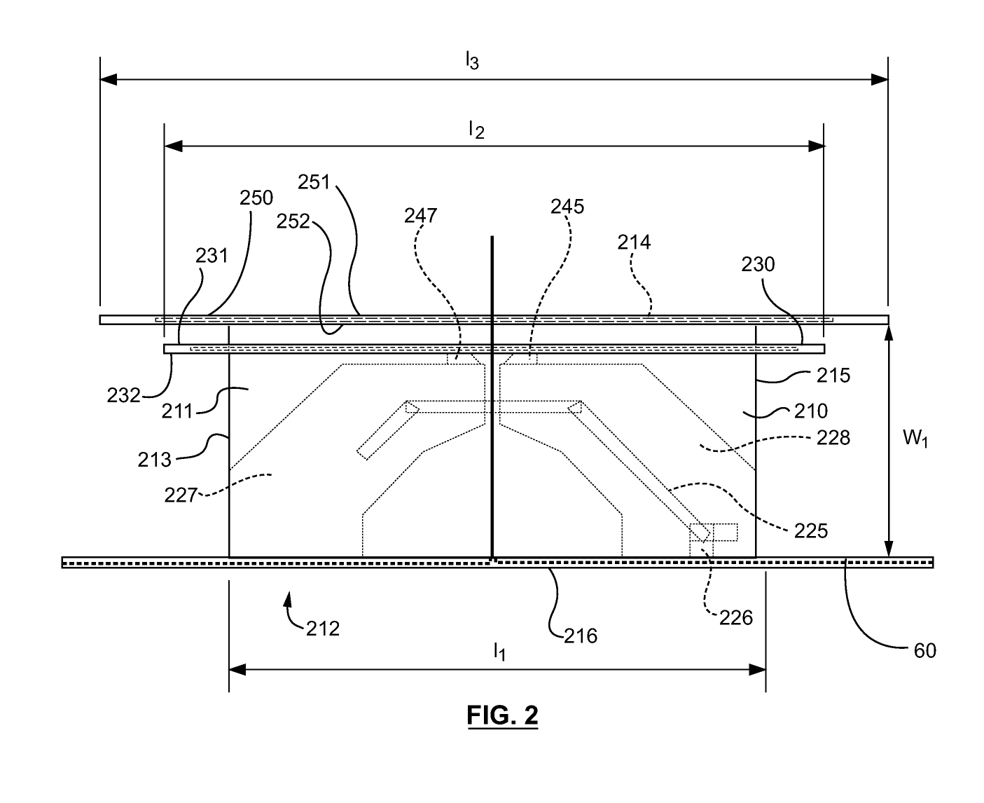

FIGS. 1-3 show several views of the dipole elements 20, 30. With respect to FIG. 2 only the first dipole element 20 is described since the second dipole element 30 is almost identical to the first dipole element 20. In some embodiments, however, the second dipole element 30 may be different from the first dipole element 20. FIGS. 1-3 show how the element topology is highly symmetric about the central axis (z).

FIG. 1 shows a perspective view of the dipole element 20. The dipole element 20 includes three dielectric substrates 210, 230, 250 (e.g., circuit boards). The dipole element 20 includes a vertical substrate 210, a first horizontal substrate 230 and a second horizontal substrate 250. The vertical substrate 210 may be orthogonally arranged to a plane of the antenna reflector 60 while the first and second horizontal substrates 230, 250 may be arranged parallel to the antenna reflector 60. The vertical substrate 210 may be placed with a side surface on the antenna reflector 60.

Each of the first and second dipole elements 20, 30 may include an inclined micro-strip balun integrated into the dielectric substrate. The inclined balun is electrically connected to the dipole probes of the lower dipole and the upper dipole. The lower dipole may excite the upper dipole. In the illustrated embodiment, the balun is inclined to minimize or at least reduce the height of the antenna as measured above the conductive ground plane. The resulting antenna is more compact, i.e. has a low profile. In the illustrated example, the balun may be inclined at 30-60 degrees or, in a more specific case, at 40-50 degrees.

As shown by way of example in FIG. 2, the vertical substrate 210 comprises a first main surface 211, a second main surface 212 and side surfaces 213-216 connecting the first main surface 211 and the second main surface 212. The vertical substrate 210 may be disposed on the antenna reflector 60 such that the antenna reflector 60 is mechanically connected to a side surface 216 of the substrate 210.

The vertical substrate 210 may comprise a conductive line 225 supported by or printed on the first main surface 211. The conductive line 225 may be connected to a feed point 226. The feed point 226 is electrically isolated from the antenna reflector 60. The vertical substrate 210 may further comprise conductive plates 227, 228 supported by or printed on the second main surface 215. The conductive plates 227, 228 may be electrically connected (e.g., soldered or capacitively coupled via another PCB mounted on either side of the reflector 60) to the antenna reflector 60. The conductive plates 227, 228 are not connected to each other (except though the reflector 60) and are spaced apart by a gap. The gap is necessary to excite a differential impedance at this point. The exact differential impedance is sensitive to the dimension of the gap. The vertical substrate 210 with the gap provides a balanced feed connection to the lower dipole probe 235. The balanced feed connection may be a balanced feed impedance of about 90Ω. The vertical substrate 210 with the printed patterns 225, 227, 228 may form a balun with an unbalanced 50Ω feed point 226. In other words, the reduced size dipole is fed from a 50Ω source via an inclined balun which transforms the single ended 50Ω input into approximately 90Ω of differential impedance. As illustrated, the balun is inclined to reduce the height of the antenna element.

The vertical substrate 210 may have a length l₁ between 40 mm and 80 mm or, in one specific embodiment, a length of about 60 mm (+/−10%) and a width w₁ between 20 mm and 40 mm or, in one specific embodiment, a width of about 30 mm (+/−10%). The conductive line 225, the feed point 226 and the conductive plates 227, 228 may be made of the same conductive material such as copper or copper alloy or, alternatively, aluminum or aluminum alloy. In some embodiments the materials used to form the conductive line 225 and the conductive plates 227, 228 may be different. The conductive plates 227, 228 may be a balun ground.

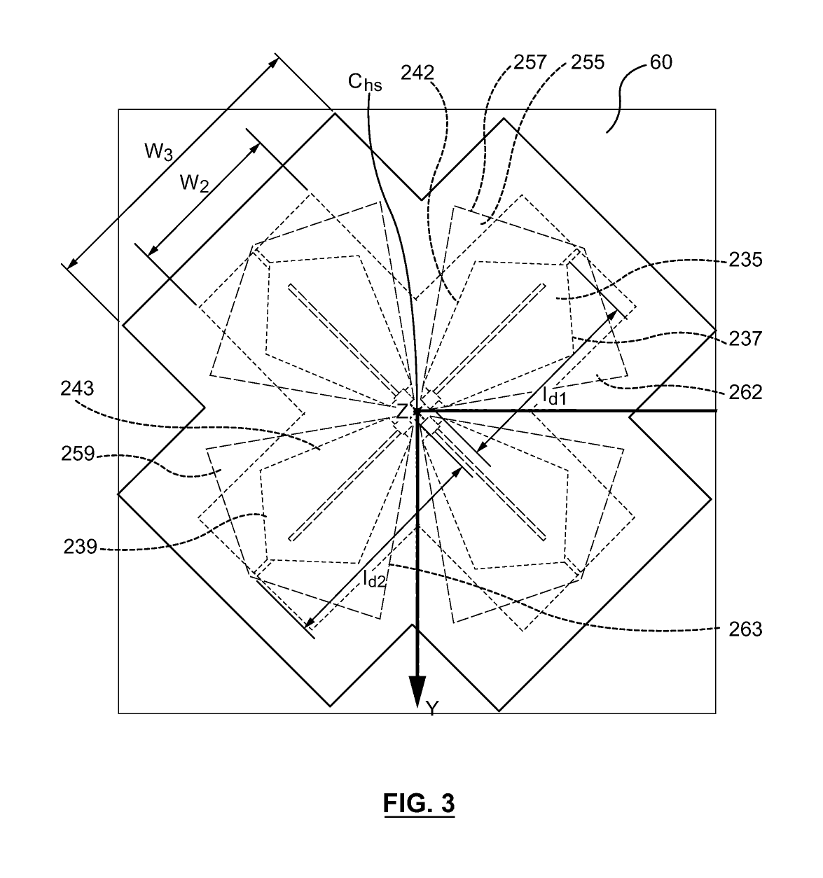

The first horizontal substrate 230 may be a lower dipole element. The first horizontal substrate 230 may be printed only on one of its main surfaces 231, 232 (as shown by way of example in FIG. 3) with a conductive material pattern 235, e.g., a lower dipole probe. The lower dipole probe 235 may be situated on the first main surface (e.g., upper main surface) 231, or, alternatively, on the second main surface (e.g., lower main surface) 232 (see FIG. 2). The lower dipole probe 235 may have two conductive plates 237, 239 having identical forms of a regular polygon such as a rhombus, diamond or kite-shaped. The rhombus may not be a symmetrical rhombus but may have longer sides 242, 243 closer to a central point Cₕₛ (so as to be kite-shaped). Alternatively, the plates 237, 239 may comprise a curvilinear shape or may be a polygon with narrow features near the central point Cₕₛ and broader or wider features at the tips to provide good bandwidth and radiation pattern. The narrowing near the central point is beneficial so that the two conductive plates 237, 239 of the lower dipole probe 235 can approach the balun gap differential feed point. This facilitates a conductive connection to the lower dipole patch. The five vertices of each plate 237, 239 can be sharp or round. The plates may have more or less than five vertices. In some embodiment, the plates 237, 239 may not be rectangular. Each of the plates 237, 239 may be electrically connected to the connection 245, 247, which may be through-vias or edge connection elements. The electrical connections 245, 247 may be established by soldering the conductive pattern of the first horizontal substrate 230 and the vertical substrate 210. The plates 237, 239 of the lower dipole probe 235 are connected via the electrical connections 245, 247 to the balanced feed point of the balun (gap between conductor plates 227, 228). The gap of the conductor plates 227, 228 may be the same as the gap between the conductors 245, 247. This balance feed point is configured to be excited by the balun input port 226. Whereas conventional dipole elements feed the dipole wings directly from the balun differential impedance point, such a topology would yield a decreased bandwidth with the increased height. However, the coupled dipole probe feed of the illustrated embodiment increases the bandwidth so that the low-profile antenna can achieve comparable bandwidths to higher profile antennas. The geometry of the illustrated embodiment furthermore permits a nested third polarization to be accommodated within the space or void directly under the antenna's central axis, i.e. under the dipole elements.

The first horizontal substrate 230 may have a length l₂ between 60 mm and 100 mm or, in a specific embodiment, a length l₂ of about 80 mm (+/−10%) and a width w₂ between 20 mm and 40 mm or, in a specific embodiment, a width w₂ of about 30 mm (+/−10%). Each conductive plate 237, 239 of the lower dipole probe 235 may have a length l_{d1} of about λ/4. For the purposes of this specification, “about λ/4” means λ/4+/−10%, or alternatively, λ/4+/−5%, or even λ/4+/−2%. The first horizontal substrate 230 may be longer than the first vertical substrate 210. The conductive material pattern may comprise a conductive material such as copper or copper alloy or, alternatively, aluminum or aluminum alloy.

The second horizontal substrate 250 may be an upper dipole element. The second horizontal substrate 250 may be printed only on one of its main surfaces 251, 252 (as shown by way of example in FIG. 2) with a conductive material pattern 255, e.g., an upper dipole probe (as shown by way of example in FIG. 3). The upper dipole probe 255 may be situated on the first main surface (e.g., upper main surface) 251. The upper dipole probe 255 may include two conductive plates 257, 259 having identical forms of a regular polygon such as a rhombus or diamond or kite. The rhombus may not be a symmetrical rhombus but may have longer sides 262, 263 closer to a central point Cₕₛ so as to be kite-shaped. Alternatively, the plates 257, 259 may have a curvilinear shape or may be polygons as described above with respect to the plates 237, 239. The plates 257, 259 of the upper dipole probe 255 may approach the central point Cₕₛ so that the small capacitance can be placed there with a small inductance connection. In some embodiments, the plates 257, 259 may not be rectangular.

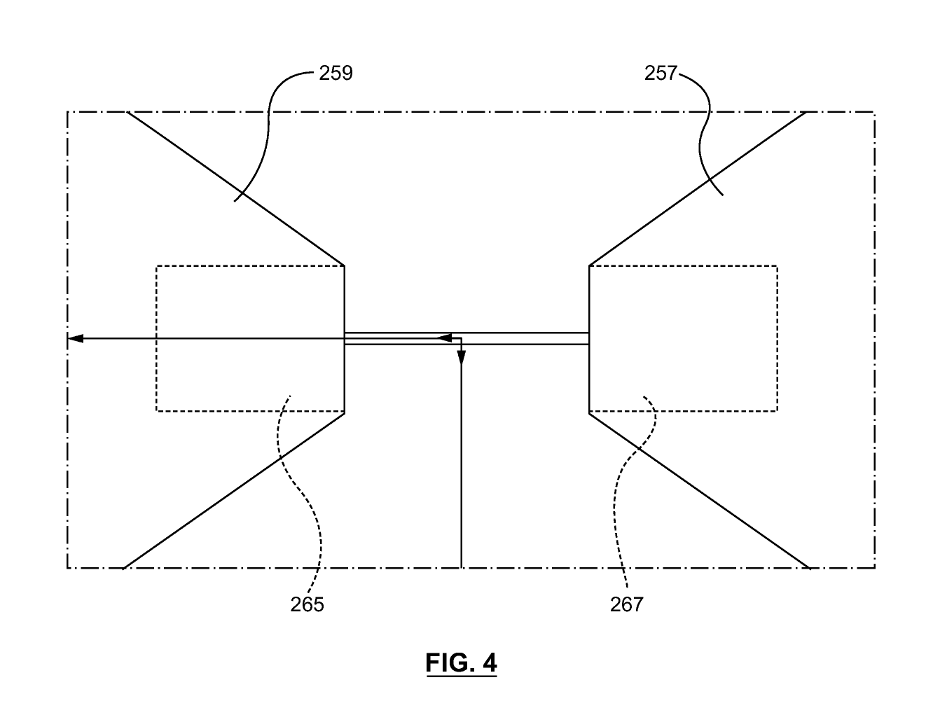

FIG. 4 shows a capacitive connection at the dipole center. As depicted by way of example in FIG. 4, each of the plates 257, 259 may be capacitively connected (or, alternatively, inductively connected) to a capacitor 265 as shown by way of example in FIG. 4. The capacitor 265 may be located on the lower (second) main surface 252. The capacitor 265 may be a parallel plate capacitor. The capacitor 265 creates a capacitive connection between the two plates 257, 259. There is no capacitive connection or capacitor for the lower dipole probe 235. The capacitance of the capacitor 265 has the effect of broadening the frequency band of the dipole input impedance match.

The second horizontal substrate 250 may have a length l₂ between 80 mm and 120 mm or, in one specific embodiment, a length l₂ of about 100 mm (+/−10%) and a width w₂ between 30 mm and 50 mm or, in one specific embodiment, a width w₂ of about 40 mm (+/−10%). Each conductive plate 257, 259 of the upper dipole probe 235 may have a length l_{d2} of about λ/4. In some embodiments, the total length, end to end, of the upper dipole probe 255 is approximately λ/2 near the lower end of the frequency band while the total length, end to end, of the smaller lower dipole probe 235 is approximately λ/2 near the upper end of the frequency band. Such a configuration provides high bandwidth. In a specific embodiment, the total length of the upper dipole may be approximately 6.25 cm and the total length of the lower dipole may be approximately 6 cm for the lower dipole (for Wi-Fi 2.4 GHz-2.5 GHz). In this specific embodiment, the height may be approximately 2 cm (λ/6).

In the illustrated embodiment, the second horizontal substrate 250 is longer and wider than the first horizontal substrate 230. The conductive material pattern may be made of any suitable conductive material such as copper or copper alloy or, alternatively, aluminum or aluminum alloy.

In some embodiments, there is no conductive connection between the first dipole element 235 and the second dipole element 255. The distance between the lower dipole element 230 to the upper dipole element 250 may affect the magnitude of the coupling. The distance may be about 1 mm to 5 mm, or in a specific embodiment, about 2 mm to 3 mm.

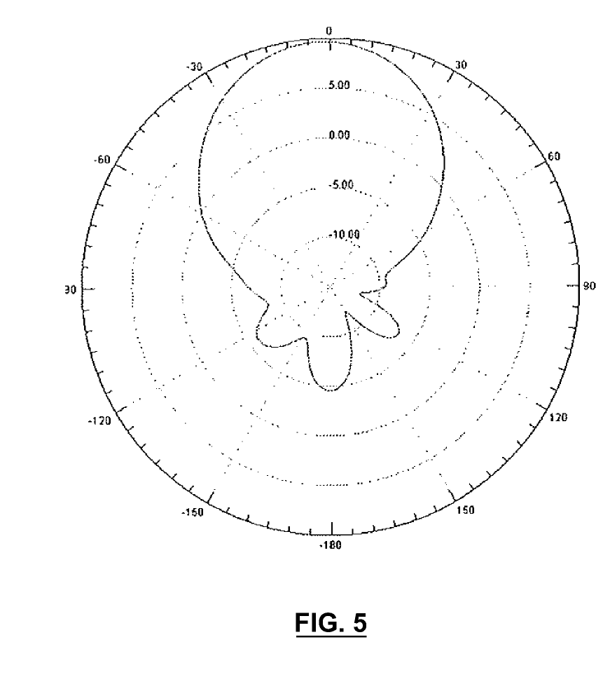

FIG. 5 depicts the radiation pattern of the dipole elements 20, 30 of the illustrated embodiment. It will be appreciated that the radiation pattern may vary based on the characteristics and geometry of the dipole elements.

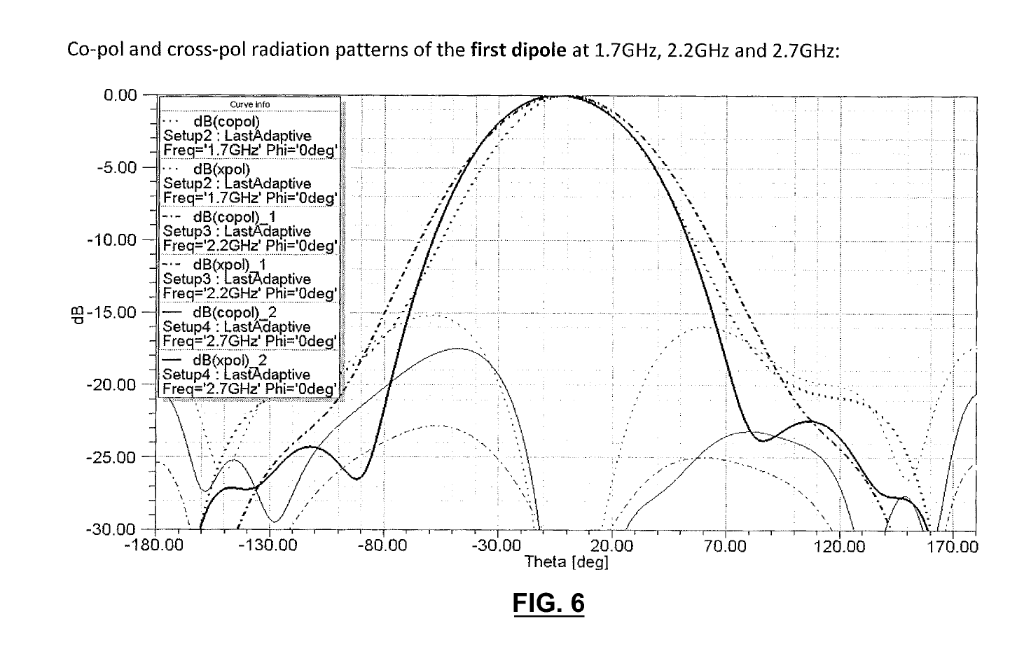

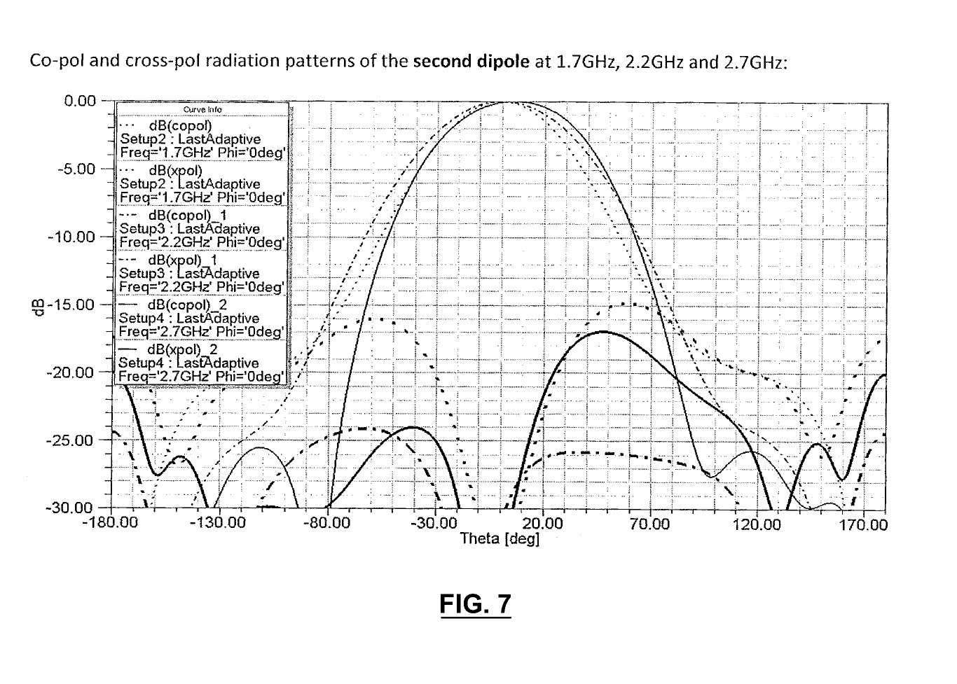

The performance of the compact antenna element 10, as illustrated in FIGS. 6-7, is surprisingly better when the elements 20, 30 are located closer to each other than further away. These two independent antenna elements are co-located substantially symmetrically about the central axis (C-axis). This symmetry is believed to be a key factor in obtaining high isolation between the co-located elements. In this implementation, the port-to port isolation is better than 30 dB, and cross pole discrimination (polarization purity) is excellent, as shown in FIGS. 5-6.

FIG. 6 shows the co-polarization radiation and the cross-polarization radiation of the first dipole element 20 (integrated in the compact antenna element 10) at 1.7 GHz, 2.2 GHz and 2.7 GHz while FIG. 7 shows the co-polarization radiation and the cross-polarization radiation of the second dipole element 30 for the same frequencies. As can be seen from these plots, the cross-polarization pattern for the first and second dipole elements 20, 30 are lower than −15 dB. Both dipole elements show the same good performance in the whole frequency range: low side lobes (lower than −20 dB), low back radiation and small variation of the beam-width within the frequency range.

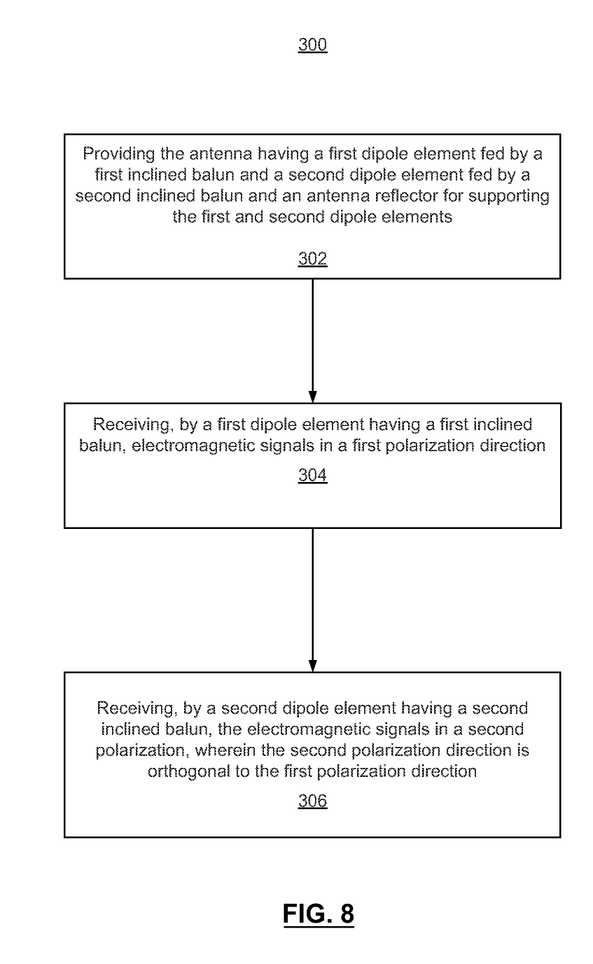

FIG. 8 shows a method 300 for operating the compact antenna element to receive a signal. The method entails providing (step 302) the antenna having a first dipole element fed by a first inclined balun and a second dipole element fed by a second inclined balun and an antenna reflector for supporting the first and second dipole elements. The method entails receiving (step 304) orthogonal signal components at the first and second dipole elements and conducting the signal components to respective inclined baluns, i.e. step 304 entails receiving, by a first dipole element having a first inclined balun, electromagnetic signals in a first polarization direction. Step 306 entails receiving, by a second dipole element having a second inclined balun, the electromagnetic signals in a second polarization, wherein the second polarization direction is orthogonal to the first polarization direction. In other words, the compact antenna element, which includes two dipole elements, receives an electromagnetic signal. The electromagnetic signal may comprise an electromagnetic signal component for each of the orthogonal polarization directions. The first polarized dipole element receives or picks up a first electromagnetic signal component in its polarization direction and the second polarized dipole element receives or picks up a second electromagnetic signal component in its direction. The compact antenna element transmits these electromagnetic signal components to the respective feed points of the compact antenna elements via inclined baluns of the compact antenna element.

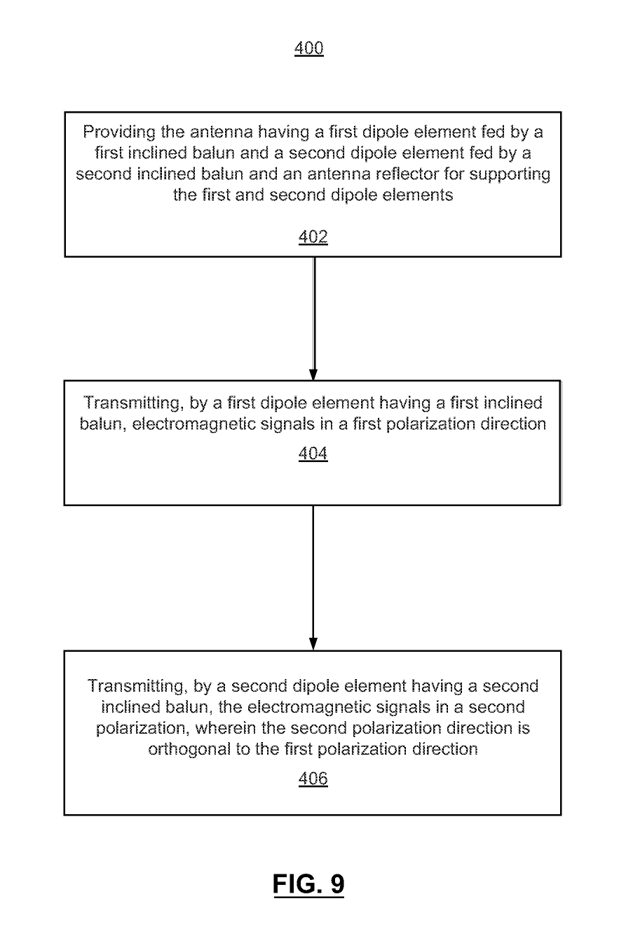

FIG. 9 shows a method 400 for operating the compact antenna element to transmit a signal. The method entails providing (402) the antenna having a first dipole element fed by a first inclined balun and a second dipole element fed by a second inclined balun and an antenna reflector for supporting the first and second dipole elements, transmitting (404), by a first dipole element having a first inclined balun, electromagnetic signals in a first polarization direction, and transmitting (406), by a second dipole element having a second inclined balun, the electromagnetic signals in a second polarization, wherein the second polarization direction is orthogonal to the first polarization direction. In other words, a signal is transmitted through each inclined balun of the compact antenna to the respective feed point for each of the two dipole radiating elements. The inclined balun transmits the signal via an electrical connection to the lower dipole probe. The lower dipole probe excites the upper dipole probe. The dipole radiating elements then radiate orthogonal electromagnetic signals.

The compact antenna described herein may be used in an antenna array to form a compact antenna array.

An antenna or antenna array constructed according to the embodiments disclosed herein may be used for frequency bands between 300 MHz and 30 GHz. For example, the antenna can be operated in GSM, UMTS or LTE wireless systems. The applicable frequency bands may be 790 MHz-860 MHz, 1.7 GHz-1.9 GHz, and 2.5 GHz-2.7 GHz. An antenna constructed in accordance with other embodiments may be used for 2.4 GHz-2.5 GHz and 5 GHz-6 GHz (Wi-Fi band). Alternatively, other embodiments of the antenna may be used in the 60 GHz band, e.g., 57 GHz-66 GHz, in the E-band (e.g., 71 GHz-76 GHz and 81 GHz-86 GHz) and in the 90 GHz band, e.g., 92 GHz-95 GHz.

Other embodiments of the invention may be applied to other RF emitting or radiating elements that employ dipole-radiating elements such as, for example, radar systems such as automotive radar or telecommunication applications such as transceiver applications in base stations or user equipment (e.g., mobile communication device or other handheld wireless communication device). Accordingly, the antenna disclosed herein may be incorporated within a wireless apparatus (such as a mobile communication device or base station transceiver). Such an apparatus thus includes an antenna having a first dipole element configured to emit or receive electromagnetic signals in a first polarization direction, wherein the first dipole has a first inclined balun, a second dipole element configured to emit or receive electromagnetic signals in a second polarization direction, wherein the second polarization direction is orthogonal to the first polarization direction, and the second dipole has a second inclined balun, and an antenna reflector upon which are mounted the first and second dipole elements. The apparatus includes a wireless transceiver connected to the antenna.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. An antenna comprising:
a first dipole element configured to emit or receive electromagnetic signals in a first polarization direction, wherein the first dipole has a first inclined balun; and
a second dipole element configured to emit or receive electromagnetic signals in a second polarization direction, wherein the second polarization direction is orthogonal to the first polarization direction, and the second dipole has a second inclined balun.

2. The antenna of claim 1, wherein each of the first and second dipole elements includes a first horizontal substrate including a lower dipole probe, a second horizontal substrate disposed above the first horizontal substrate, the second horizontal substrate including an upper dipole probe, and a vertical substrate that includes the first or second inclined balun.

3. The antenna of claim 2, wherein the lower dipole probe comprises two conductive plates and wherein the upper dipole probe comprises two conductive plates.

4. The antenna of claim 3, wherein plates of the lower and upper dipole probes are substantially kite-shaped.

5. The antenna of claim 4, wherein the second horizontal substrate is longer and wider than the first horizontal substrate.

6. The antenna of claim 5, wherein the plates of the lower dipole probe are smaller than the plates of the upper dipole probe.

7. The antenna of claim 1, wherein the first and second inclined balun are each inclined at an angle of 30-60 degrees.

8. The antenna of claim 2, wherein the vertical substrate has a length less than a length of the first horizontal substrate and wherein the first horizontal substrate is shorter in length than the second horizontal substrate.

9. The antenna of claim 3, wherein the plates of the lower dipole probe are connected via electrical connections to a balanced feed point of the balun.

10. The antenna of claim 3, wherein the plates of the upper dipole probe are connected to a capacitor.

11. The antenna of claim 2, wherein the inclined balun is electrically connected to the lower dipole probe and wherein the lower dipole probe excites the upper dipole.

12. The antenna of claim 2, wherein a length of the upper dipole probe is λ/2 near a lower end of a frequency band while the length of the lower dipole probe is λ/2 near an upper end of the frequency band.

13. The antenna of claim 2, wherein a conductive plate of the upper dipole probe and of the lower dipole probe has a length of λ/4.

14. The antenna of claim 1, wherein a height of the antenna is λ/6.

15. The antenna of claim 1, comprising an antenna reflector upon which are mounted the first and second dipole elements.

16. A method of using an antenna to receive a signal, the method comprising:
receiving, by a first dipole element having a first inclined balun, electromagnetic signals in a first polarization direction;
receiving, by a second dipole element having a second inclined balun, the electromagnetic signals in a second polarization;
wherein the second polarization direction is orthogonal to the first polarization direction.

17. A wireless apparatus comprising:
an antenna including:
a first dipole element configured to emit or receive electromagnetic signals in a first polarization direction, wherein the first dipole has a first inclined balun;
a second dipole element configured to emit or receive electromagnetic signals in a second polarization direction, wherein the second polarization direction is orthogonal to the first polarization direction, and the second dipole has a second inclined balun; and
an antenna reflector upon which are mounted the first and second dipole elements; and
a wireless transceiver connected to the antenna.

18. The wireless apparatus of claim 17 wherein the wireless transceiver is part of a base station transceiver.

19. The wireless apparatus of claim 17 wherein the wireless transceiver is part of a mobile communication device.
